(19) United States
(12) Patent Application Publication
(10) Pub. No.: US 2023/0371548 A1
(43) Pub. Date: Nov. 23, 2023

(54) ANIMAL FEED AND METHODS OF MANUFACTURE

(71) Applicant: Double Down Deer Feed LLC, Rosenberg, TX (US)

(72) Inventors: Brett Marshall Holden, Richmond, TX (US); Jeramie Vinklarek, Cypress, TX (US)

(73) Assignee: Double Down Deer Feed LLC, Rosenberg, TX (US)

(21) Appl. No.: 17/750,949

(22) Filed: May 23, 2022

(51) Int. Cl. A23K 10/30; A23K 20/20; A23K 20/174

(52) U.S. Cl. CPC A23K 10/30; A23K 20/30; A23K 20/174

(57) ABSTRACT

An improved animal feed including flavorings, vitamins, and minerals is disclosed. Applications of the novel composition of flavorings, vitamins, and minerals was found to provide greatly increased rates of consumption of the animal feed by wildlife. This novel composition for application to animal feed should be of great importance to hunters, farmers, and ranchers or others that desire to attract and maintain wildlife within a certain area or to encourage repeat visitations by the wildlife.

### CROSS-REFERENCE TO RELATED APPLICATIONS

Not applicable.

### STATEMENT REGARDING FEDERALLY SPONSORED RESEARCH

Not applicable.

### BACKGROUND

The present invention generally relates to improved animal feeds and methods of manufacture.

Wildlife enthusiast, including hunters, zookeepers, farmers, ranchers, game wardens, and others, often use feed to attract wildlife. Enthusiast may distribute feed in a specific location to attract a variety of wildlife. For example, bird watchers may distribute a variety of seed in a bird feeder or on the ground to attract birds. As a further example, hunters may distribute corn feed through a feeder or by hand on the ground at or near the location the hunter intends to hunt the deer that come to the feed.

Hunters, farmers, and ranchers often desire animal feed products that are more attractive to certain wildlife and livestock animals. Additionally, they also desire animal feed products that will provide nutrients to assist the game animals or livestock in producing better meat, antlers, offspring, or generally providing for better quality growth and health of the animal. Some hunters, herd managers, or property owners also desire to use attractants to entice game animals on to their property or keep animals on their property for hunting or herd management.

### SUMMARY

In some embodiments, the present invention is an improved animal feed composition and methods of manufacture. In some embodiments, the present invention is a wildlife and/or livestock feed composition comprising one or more flavorings, vitamins, and minerals. In other embodiments, the present invention is a deer feed comprising corn further comprising one or more flavorings, vitamins, and minerals. In other embodiments, the present invention is a deer feed composition comprising shelled corn with an application of a composition of one or more of a licorice or anise flavoring, vitamin A, vitamin E, zinc, copper, cobalt, iron, and/or amino acids.

In several embodiments, the present invention comprises a novel composition of one or more flavorings, vitamins, and/or minerals to feed products and methods of manufacturing the same. The process of applying the novel composition to feed products may include mixing, spraying, misting, fogging, dipping, soaking, baking, bonding, submersion, flooding, and/or a combination of any of these processes.

In several embodiments, the present invention comprises various feed base product ingredients comprising one or more of corn (shelled, rolled, cracked, meal), peanut (shelled or raw), cotton seed (linted or de-linted), soybean (roasted or raw), milo, beans, and/or sunflower seed (roasted, raw, or shelled). In their testing the inventors found that the application of their novel “DD” composition produced increased consumption rates and preference of the feed by animals versus feeds without the application of the novel DD composition.

In field tests and experiments, the inventors found that certain ranges of ratios of flavoring, vitamins, and minerals applied to a corn based feed product provided numerous benefits such as increased consumption of the corn, preference of the corn over other compositions of flavoring, vitamins, and/or minerals applied to a corn based feed product, and preference of the corn feed product over other types of feed base products, such as peanut, cotton seed, soybean, and/or sunflower seed. The inventors also found that application of the certain ranges of ratios of flavoring, vitamins, and minerals to feed base products other than corn, such as peanut, cotton seed, soybean, and/or sunflower seed, provided the same or similar benefits mentioned above versus other feed products that did not include the application of the certain ranges of ratios of flavoring, vitamins, and minerals conceived of by the inventors.

In field tests and experiments, the inventors found that the disclosed and claimed feed product when applied with the novel DD composition of one or more flavorings, vitamins, and/or minerals, provided additional benefits such as improved nutrition, improved muscle and bone growth of the deer, improved antler growth and quality, and improved fur coat appearances. These improvements were only observed with the novel DD composition applied to the feed product as described and claimed herein versus other feed products without the application of the novel DD compositions.

The inventors field tested and experimented with various forms of application. Initial testing and experimentation involved the use of granular forms of one or more flavorings, vitamins, and/or minerals. As experimentation and fielding testing continued, the inventors found that liquid forms or liquid suspensions of one or more flavorings, vitamins, and/or minerals provided better results such as more even distributions of the components and better adherence to the animal feed product. The liquid forms or liquid suspensions of one or more flavorings, vitamins, and/or minerals allow for spraying of the forms or suspensions on to the animal feed product providing for the aforementioned better results over earlier granular forms. While spraying is mentioned in this particular instance, it should be understood that other methods of application can be used as disclosed herein.

While some embodiments of the present invention are targeted to attracting and feeding deer other animals, including ruminants, can also benefit from the improved animal feed composition and methods disclosed and claimed herein.

The inventors are unaware of any other raw, shelled, rolled, and/or powdered corn product that has been or is produced utilizing the unique and novel improved animal feed and methods of manufacture disclosed and claimed herein.

### BRIEF DESCRIPTION OF THE DRAWINGS

For a more complete understanding of the present disclosure and the advantages thereof, reference is now made to the following descriptions to be taken in conjunction with the accompanying figures describing specific embodiments of the disclosure, wherein:

FIG. 1 illustrates one embodiment of the method of manufacture.

FIG. 2 illustrates one embodiment of the method of manufacture.

### DETAILED DESCRIPTION

One or more illustrative embodiments incorporating the invention disclosed herein are presented below. The inventors have conceived and prepared a revolutionary and improved animal feed composition and methods of manufacture.

In the following description, certain details are set forth such as specific quantities, sizes, etc. to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art. However, as discussed herein, some embodiments of the present invention were found to have improved performance characteristics such as improved attraction, improved consumption rates, and improved health benefits to the animals consuming the improved animal feed composition.

Referring to the figures in general, it will be understood that the illustrations are for the purpose of describing embodiments of the disclosure and are not intended to be limiting thereto. Figures are not necessarily to scale, and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. Definitions and/or interpretations should not be incorporated from other patent applications, patents, or publications, related or not, unless specifically stated in this specification, or if the incorporation is necessary for maintaining validity.

While preferred embodiments have been shown, and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

During their testing the inventors found that different compositions of flavorings, vitamins, and/or minerals, and other inclusions provided improved consumption rates by wildlife, especially deer, versus other compositions not including the inventors' novel composition of flavorings, vitamins, and/or minerals. In their initial testing the inventors found that the consumption rate for their novel DD composition to be a two-fold improvement over typical unflavored corn feed. The inventors used a composition of granulated anise in combination with corn feed and prepared the composition by hand. The inclusion rates were at 5 pounds per ton to provide an even flavoring component. As shown in the chart below, the wildlife preferred and consumed the inventors' novel DD composition at or more than twice the rate of typical corn feed without flavoring. The amounts shown in Tables 1-7 are the amounts of feed consumed in pounds. The inventors' novel composition is identified in the tables below as “DD”.

TABLE 1

| | REG | DD | |
|---|---|---|---|
| | CORN FED | CORN FED | DIFFERENCE |
| | (LBS) | (LBS) | (LBS) |
| Test 1 | 15.00 | 35.00 | 20.00 |
| Test 2 | 15.00 | 35.00 | 20.00 |
| Test 3 | 10.00 | 40.00 | 30.00 |
| Test 4 | 10.00 | 40.00 | 30.00 |
| Test 5 | 15.00 | 35.00 | 20.00 |
| Test 6 | 20.00 | 40.00 | 20.00 |
| Test 7 | 25.00 | 55.00 | 30.00 |
| Test 8 | 35.00 | 75.00 | 40.00 |
| Test 9 | 35.00 | 80.00 | 45.00 |
| Test 10 | 40.00 | 120.00 | 80.00 |
| Test 11 | 50.00 | 150.00 | 100.00 |
| Test 12 | 50.00 | 200.00 | 150.00 |
| Total (LBS) | 320.00 | 905.00 | 585.00 |
| Total (TONS) | 0.16 | 0.45 | 0.29 |
| Average per Test | 26.67 | 75.42 | 48.75 |

In their second round of testing, the inventors found that reducing the inclusion rate of granulated anise, as a flavoring, from 5 pounds per ton to 3 pounds per ton did not result in a significant difference for consumption by the wildlife. In this round of testing, the wildlife still preferred the inventor's novel DD composition over typical unflavored corn feed at a greatly increased rate. The change in inclusion rate from 5 pounds per ton to 3 pounds per ton began in Test 6 as indicated in Table 2.

TABLE 2

| | REG | DD | | |
|---|---|---|---|---|
| | CORN FED | CORN FED | | DIFFERENCE |
| | (LBS) | (LBS) | | (LBS) |
| Test 1 | 10.00 | 40.00 | | 30.00 |
| Test 2 | 10.00 | 40.00 | | 30.00 |
| Test 3 | 10.00 | 35.00 | | 25.00 |
| Test 4 | 5.00 | 40.00 | | 35.00 |
| Test 5 | 10.00 | 40.00 | | 30.00 |
| Test 6 | 15.00 | 40.00 | * | 25.00 |
| Test 7 | 20.00 | 45.00 | | 25.00 |
| Test 8 | 25.00 | 80.00 | | 55.00 |
| Test 9 | 25.00 | 80.00 | | 55.00 |
| Test 10 | 30.00 | 120.00 | | 90.00 |
| Test 11 | 35.00 | 150.00 | | 115.00 |
| Test 12 | 40.00 | 200.00 | | 160.00 |
| Total (LBS) | 235.00 | 910.00 | | 675.00 |
| Total (TONS) | 0.12 | 0.46 | | 0.34 |
| Average per Test | 19.58 | 75.83 | | 56.25 |

In their third round of testing, the inventors found that that starting with Test 10 in Round 3 that there was a slight reduction in consumption observed versus tests performed in Round 2. The inclusion rate for Round 3 was 5 pounds per ton, which was the same inclusion rate as the start of Round 2. The inventors still observed a marked difference in consumption rates for their novel composition of flavorings, minerals, and/or vitamins versus typical corn feed without added flavoring.

TABLE 3

| | REG | DD | DIFFERENCE |
|---|---|---|---|
| | CORN (LBS) | CORN (LBS) | (LBS) |
| Test 1 | 10.00 | 40.00 | 30.00 |
| Test 2 | 10.00 | 40.00 | 30.00 |
| Test 3 | 15.00 | 40.00 | 25.00 |
| Test 4 | 10.00 | 40.00 | 30.00 |
| Test 5 | 15.00 | 40.00 | 25.00 |
| Test 6 | 15.00 | 40.00 | 25.00 |
| Test 7 | 20.00 | 45.00 | 25.00 |
| Test 8 | 25.00 | 85.00 | 60.00 |
| Test 9 | 25.00 | 90.00 | 65.00 |
| Test 10 | 30.00 | 110.00 | 80.00 |
| Test 11 | 35.00 | 145.00 | 110.00 |
| Test 12 | 40.00 | 180.00 | 140.00 |
| Total (LBS) | 250.00 | 895.00 | 645.00 |
| Total (TONS) | 0.13 | 0.45 | 0.32 |
| Average per | 20.83 | 74.58 | 53.75 |
| Test | | | |

In their fourth round of testing, the inventors beginning with Test 4 decreased the amount of granulated anise flavoring to 2 pounds per ton and decreased the included minerals to 3 pounds per ton. As demonstrated in Table 4, this decrease did not significantly alter the consumption rates versus earlier rounds of testing. Still, inventors' novel DD composition was significantly preferred and consumed over typical corn feed without added flavoring.

TABLE 4

| | REG | DD | | DIFFERENCE |
|---|---|---|---|---|
| | CORN (LBS) | CORN (LBS) | | (LBS) |
| Test 1 | 10.00 | 35.00 | | 25.00 |
| Test 2 | 10.00 | 35.00 | | 25.00 |
| Test 3 | 15.00 | 40.00 | | 25.00 |
| Test 4 | 10.00 | 40.00 | * | 30.00 |
| Test 5 | 15.00 | 40.00 | | 25.00 |
| Test 6 | 20.00 | 45.00 | | 25.00 |
| Test 7 | 25.00 | 45.00 | | 20.00 |
| Test 8 | 35.00 | 90.00 | | 55.00 |
| Test 9 | 30.00 | 120.00 | | 90.00 |
| Test 10 | 35.00 | 165.00 | | 130.00 |
| Test 11 | 45.00 | 180.00 | | 135.00 |
| Test 12 | 50.00 | 215.00 | | 165.00 |
| Total (LBS) | 300.00 | 1050.00 | | 750.00 |
| Total (TONS) | 0.15 | 0.53 | | 0.38 |
| Average per | 25.00 | 87.50 | | 62.50 |
| Test | | | | |

In their fifth round of testing, the inventors tested other flavorings to compare typical unflavored corn feed with other flavorings, such as apple or orange flavorings, with their novel DD composition that uses anise or licorice. Starting with Test 4 of Round 5, the inventors removed all granulated minerals from their novel composition. Additionally, the inventors began to apply a liquid anise flavoring rather than using a granulated anise flavoring. The inventors found that the application of liquid anise flavoring provided a more even and effective coverage on the corn feed. This is in part due to the liquid being able to adhere to the corn feed rather than being dry mixed and able to flake off of the corn feed during transport or distribution.

TABLE 5

| | REG | APPLE | ORANGE | DD |
|---|---|---|---|---|
| | CORN | CORN | CORN | CORN |
| | (LBS) | (LBS) | (LBS) | (LBS) |
| Test 1 | 5.00 | 10.00 | 5.00 | 35.00 |
| Test 2 | 0.00 | 10.00 | 5.00 | 30.00 |
| Test 3 | 5.00 | 5.00 | 0.00 | 45.00 |
| Test 4 | 0.00 | 5.00 | 5.00 | 55.00* |
| Test 5 | 5.00 | 10.00 | 10.00 | 55.00 |
| Test 6 | 0.00 | 15.00 | 15.00 | 55.00 |
| Test 7 | 0.00 | 15.00 | 15.00 | 65.00 |
| Test 8 | 5.00 | 25.00 | 25.00 | 100.00 |
| Test 9 | 10.00 | 25.00 | 15.00 | 110.00 |
| Test 10 | 10.00 | 30.00 | 20.00 | 140.00 |
| Test 11 | 15.00 | 25.00 | 15.00 | 195.00 |
| Test 12 | 20.00 | 30.00 | 15.00 | 220.00 |
| Total (LBS) | 75.00 | 205.00 | 145.00 | 1105.00 |
| Total (TONS) | 0.04 | 0.10 | 0.07 | 0.55 |
| Average per | 6.25 | 17.08 | 12.08 | 92.08 |
| Test | | | | |

The inventors in their sixth round of testing began to test on other feed base ingredients including, but not limited to, cottonseed, peanut, soybean, and/or sunflower seed. With Test 1 of Round 6, the inventors began to include zinc and copper minerals in their novel DD composition. With Test 7 of Round 6, the inventors began to include vitamin A and vitamin E in granulated form in their novel DD composition. As demonstrated in Table 6, the animals greatly preferred the inventors' novel DD composition.

TABLE 6

| | REG | APPLE | ORANGE | DD |
|---|---|---|---|---|
| | CORN | CORN | CORN | CORN |
| | (LBS) | (LBS) | (LBS) | (LBS) |
| Test 1 | 5.00 | 10.00 | 5.00 | 40.00* |
| Test 2 | 0.00 | 5.00 | 5.00 | 35.00 |
| Test 3 | 5.00 | 5.00 | 0.00 | 45.00 |
| Test 4 | 0.00 | 5.00 | 5.00 | 55.00 |
| Test 5 | 5.00 | 5.00 | 5.00 | 60.00 |
| Test 6 | 0.00 | 10.00 | 10.00 | 60.00 |
| Test 7 | 0.00 | 15.00 | 10.00 | 60.00* |
| Test 8 | 5.00 | 20.00 | 20.00 | 110.00 |
| Test 9 | 10.00 | 25.00 | 10.00 | 110.00 |
| Test 10 | 10.00 | 35.00 | 15.00 | 160.00 |
| Test 11 | 15.00 | 30.00 | 10.00 | 220.00 |
| Test 12 | 20.00 | 25.00 | 20.00 | 235.00 |
| Total (LBS) | 75.00 | 190.00 | 115.00 | 1190.00 |
| Total (TONS) | 0.04 | 0.10 | 0.06 | 0.60 |
| Average per | 6.25 | 15.83 | 9.58 | 99.17 |
| Test | | | | |

The inventors in their seventh round of testing began to use an application of liquid forms of each of the ingredients added to their novel DD composition. Again, the inventors tested typical corn feed without added flavoring against an apple flavored corn feed, an orange flavored corn feed, and their novel DD composition corn feed. In Test 1, the inventors included a liquid form of anise flavoring at an inclusion rate of 0.5 pounds per ton. In Test 2, the inventors included a liquid form of vitamin A at a minimum of 600 international units (“IU”) per pound and vitamin E at a minimum of 200 IU per pound. In Test 3, the inventors added liquid copper sulfate at a minimum 5 parts per million (ppm) and liquid zinc sulfate at a minimum of 10 parts per million. As demonstrated in Table 6, the animals greatly preferred the inventors' novel DD composition as shown by the greatly increased consumption rates by the animals.

TABLE 7

| | REG | APPLE | ORANGE | DD |
|---|---|---|---|---|
| | CORN | CORN | CORN | CORN |
| | (LBS) | (LBS) | (LBS) | (LBS) |
| Test 1 | 5.00 | 5.00 | 0.00 | 45.00* |
| Test 2 | 0.00 | 5.00 | 0.00 | 55.00* |
| Test 3 | 5.00 | 5.00 | 5.00 | 55.00* |
| TOTAL (LBS) | 10.00 | 15.00 | 5.00 | 155.00 |
| TOAL (TONS) | 0.01 | 0.01 | 0.00 | 0.08 |
| Average per | 3.33 | 5.00 | 1.67 | 51.67 |
| Test | | | | |

Formulation of the improved animal feed is generally calculated and ratioed per a ton of finished animal feed product, after flavorings, vitamins, minerals, and other inclusions are applied or added to the base feed stock. In some embodiments of the present invention, the formulation of the improved animal feed may include a licorice and/or anise flavoring additive at a ratio of 1/16^{th} per ton to 5 pounds per ton of finished animal feed product. In some embodiments of the present invention, the micronutrient or mineral inclusion ratios may vary based on needs, biomes, draught, or other natural and non-natural conditions, and wildlife health conditions or needs. For example, if it is known or suspected that wildlife or animals are missing a certain nutrient, micronutrient, vitamin, and/or mineral, then the improved animal feed may be formulated to include such nutrient, micronutrient, vitamin, and/or mineral or include it in a greater ratio compared to the finished animal feed product.

In some embodiments, the novel DD composition comprises shelled corn feed with anise flavoring, vitamins, and minerals. In some embodiments of the novel DD composition, the vitamins comprise one or both of vitamin A and vitamin E. In some embodiments of the novel DD composition, the minerals comprise one or both of copper and zinc. In some embodiments of the novel DD composition, the minerals may comprise one or both of copper sulfate and zinc sulfate. It should be appreciated that the flavoring, vitamins, and minerals may be included in the composition in a granulated, powdered, or liquid form, or a combination of these forms. In some embodiments, the inclusion rate of vitamin A is between 400-800 IU per pound and the inclusion rate of vitamin E is between 100-300 IU per pound. In some embodiments, the inclusion rate of vitamin A is approximately 600 IU per pound and the inclusion rate of vitamin E is approximately 200 IU per pound. In some embodiments, the inclusion rate of the mineral copper sulfate is between 3 parts per million (“ppm”) and 7 ppm and the inclusion rate of the mineral zinc sulfate is between 5 ppm and 15 ppm. In some embodiments, the inclusion rate of the mineral copper sulfate is at a minimum 5 ppm and the inclusion rate of zinc sulfate is at a minimum 10 ppm.

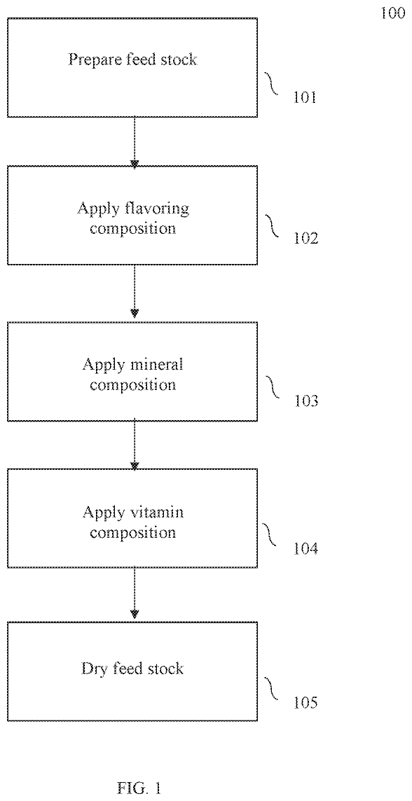

FIG. 1 illustrates a method of manufacture of the improved animal feed 100 comprising the novel DD composition. The base feed stock, generally corn, but could be any of the disclosed feed stocks herein, is first prepared for application of the various components of the novel DD composition 101. Preparation of the feed stock may include drying the feed stock, shelling or otherwise making preparing the feed stock into an edible form. It should be understood that steps 102, 103, and/or 104 may be applied in any order and that step 105 may be performed multiple times after each application in steps 102, 103, and/or 104. Once the feed stock is prepared for application of the novel DD composition, the flavoring composition is then applied to the feed stock in step 102, the mineral composition is then applied to the feed stock in step 103, and the vitamin composition is then applied to the feed stock in step 104. Once each of steps 102, 103, and 104 have been performed, the feed stock may then be dried to allow the compositions to set up or adhere to the feed stock in step 105. After the application of the novel DD composition is completed, the total feed composition may then be packaged and transported for sale, distribution, or storage. It should be appreciated that the process of applying any part of the novel DD composition to the feed may include mixing, spraying, misting, fogging, dipping, soaking, baking, bonding, submersion, flooding, and/or a combination of any of these processes. It should be appreciated that the ratios and amounts of the components to manufacture the novel DD composition and feed product can include any of the values discussed in this disclosure.

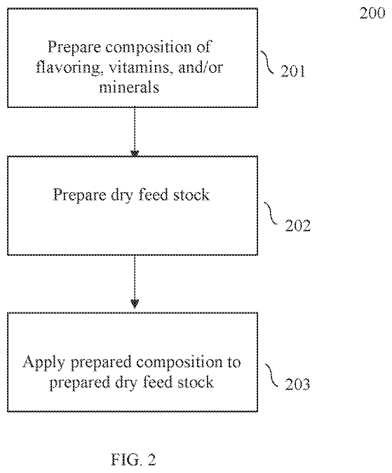

FIG. 2 illustrates an additional method of manufacture of the improved animal feed 200 comprising the novel DD composition. Step 201 in this method of manufacture is the preparation of the novel DD composition comprising the flavoring, vitamins, and/or minerals. This may be done in conjunction with the production and preparation of the feed stock or done separately and stored for later application. Once the novel DD composition is prepared, the next step is to prepare the dry feed stock at 202. Once both the feed stock and the novel DD composition are prepared, the novel DD composition is then applied to the dry feed stock through the methods of application as disclosed herein, including spraying methods, in step 203. It should be appreciated that steps 201 and 202 may be performed in either order or in conjunction. It should also be appreciated that step 201 for preparing the composition of flavoring, vitamins, and/or minerals can include any of the various combinations of components discussed herein in the various disclosed ratios and ranges. It should be appreciated that the process of applying any part of the novel DD composition to the feed may include mixing, spraying, misting, fogging, dipping, soaking, baking, bonding, submersion, flooding, and/or a combination of any of these processes. It should be appreciated that the ratios and amounts of the components to manufacture the novel DD composition and feed product can include any of the values discussed in this disclosure.

As disclosed herein, the liquid form of flavoring, particularly anise or licorice flavoring, was found to outperform granulated or powdered forms of flavoring, including anise or licorice flavoring. In either embodiment, the novel DD composition including anise or licorice flavoring, whether granulated, powdered, or liquid form, outperformed all other tested flavorings and absence of added flavoring, e.g. plain shelled corn. The granulated or powdered form of minerals was found to reduce consumption rates as compared to the liquid forms of minerals discussed herein. In either case, the inclusion of the novel DD composition of minerals outperformed other tested flavorings and absence of added flavoring, e.g. plain shelled corn. The inventors found that wildlife, especially deer, preferred and consumed the novel DD composition at a rate between two to five times greater than the same wildlife's consumption rate of unflavored feed products and other flavorings of the same variety of feed products.

Some embodiments of the present invention may include an animal feed product comprising: a feed stock comprising one or more of: peanut, cotton seed, soybean, and/or sunflower seed; a flavoring composition comprising: an anise flavoring agent; a mineral composition comprising one or more of: zinc and/or copper; and a vitamin composition comprising one or more of: vitamin A and vitamin E.

Some embodiments of the present invention may include an animal feed product comprising: a feed stock comprising corn; a flavoring composition comprising an anise flavoring agent; a mineral composition comprising one or more of: zinc and/or copper; and a vitamin composition comprising one or more of: vitamin A and vitamin E.

Some embodiments may further comprise a mineral composition comprising zinc at an inclusion rate of 5 ppm to 15 ppm and copper at an inclusion rate of 3 ppm to 7 ppm. Some embodiments may further comprise a vitamin composition comprising vitamin A at an inclusion rate of 400 to 800 IU per pound and vitamin E at an inclusion rate of 100-300 IU per pound. Some embodiments may further comprise a mineral composition of copper sulfate at an inclusion rate of a minimum of 5 ppm and zinc sulfate at an inclusion rate of a minimum 10 ppm. Some embodiments may include a vitamin composition comprising vitamin A at an inclusion rate of 500-700 IU per pound and vitamin E at an inclusion rate of 150-250 IU per pound.

Some embodiments may include an animal feed product made by the process of: preparing a feed stock; preparing a composition comprising a flavoring agent, a vitamin composition comprising one or both a vitamin A and a vitamin E, and a mineral composition comprising one or both a zinc and a copper; applying said composition to the dry feed stock.

Some embodiments may further include the animal feed product made by the above processes wherein the feed stock is one or more of corn, peanut, cotton seed, soybean, and/or sunflower seed. Some embodiments may comprise a zinc sulfate and a copper sulfate. Some embodiments may comprise a mineral composition comprising copper sulfate at an inclusion rate of a minimum of 5 ppm and zinc sulfate at an inclusion rate of a minimum 10 ppm.

Some embodiments may include a vitamin composition comprising vitamin A at an inclusion rate of 500-700 IU per pound and vitamin E at an inclusion rate of 150-250 IU per pound.

Some embodiments may include a flavoring agent. Some embodiments may include a licorice flavoring agent as the flavoring agent. Some embodiments may include an anise flavoring agent as the flavoring agent. Some embodiments may include one or more of a licorice flavoring agent and/or an anise flavoring agent as the flavoring agent.

While preferred embodiments have been shown and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied. Accordingly, it is intended that the following claims be interpreted to embrace all such variations and modifications.

What is claimed is the following:

1. An animal feed product comprising:
a feed stock comprising one or more of: peanut, cotton seed, soybean, and/or sunflower seed;
a flavoring composition comprising: an anise flavoring agent;
a mineral composition comprising one or more of: zinc and/or copper; and
a vitamin composition comprising one or more of: vitamin A and vitamin E.

2. An animal feed product comprising:
a feed stock comprising corn;
a flavoring composition comprising an anise flavoring agent;
a mineral composition comprising one or more of: zinc and/or copper; and
a vitamin composition comprising one or more of: vitamin A and vitamin E.

3. The animal feed product of claim 2 wherein:
the mineral composition comprises zinc at an inclusion rate of 5 ppm to 15 ppm and copper at an inclusion rate of 3 ppm to 7 ppm.

4. The animal feed product of claim 2 wherein:
the vitamin composition comprises vitamin A at an inclusion rate of 400 to 800 IU per pound and vitamin E at an inclusion rate of 100-300 IU per pound.

5. The animal feed product of claim 3 wherein:
the vitamin composition comprises vitamin A at an inclusion rate of 400 to 800 IU per pound and vitamin E at an inclusion rate of 100-300 IU per pound.

6. The animal feed product of claim 2 wherein:
the mineral composition copper is a copper sulfate at an inclusion rate of a minimum of 5 ppm and the mineral composition zinc is a zinc sulfate at an inclusion rate of a minimum 10 ppm.

7. The animal feed product of claim 2 wherein:
the vitamin composition comprises vitamin A at an inclusion rate of 500-700 IU per pound and vitamin E at an inclusion rate of 150-250 IU per pound.

8. The animal feed product of claim 6 wherein:
the vitamin composition comprises vitamin A at an inclusion rate of 500-700 IU per pound and vitamin E at an inclusion rate of 150-250 IU per pound.

9. An animal feed product made by the process of:
preparing a feed stock;
preparing a composition comprising a flavoring agent, a vitamin composition comprising one or both a vitamin A and a vitamin E, and a mineral composition comprising one or both a zinc and a copper;
applying said composition to the dry feed stock.

10. The animal feed product made by the process of claim 9 wherein:
the feed stock is one or more of corn, peanut, cotton seed, soybean, and/or sunflower seed.

11. The animal feed product made by the process of claim 10 wherein:
the zinc is a zinc sulfate and the copper is a copper sulfate.

12. The animal feed product made by the process of claim 11 wherein:
the mineral composition comprises the copper sulfate at an inclusion rate of a minimum of 5 ppm and the zinc sulfate at an inclusion rate of a minimum 10 ppm.

13. The animal feed product made by the process of claim 10 wherein:
the vitamin composition comprises vitamin A at an inclusion rate of 500-700 IU per pound and vitamin E at an inclusion rate of 150-250 IU per pound.

14. The animal feed product made by the process of claim 12 wherein:
the vitamin composition comprises vitamin A at an inclusion rate of 500-700 IU per pound and vitamin E at an inclusion rate of 150-250 IU per pound.

15. The animal feed product made by the process of claim 10 wherein the flavoring agent is an anise flavoring agent.

16. The animal feed product made by the process of claim 12 wherein the flavoring agent is an anise flavoring agent.

17. The animal feed product made by the process of claim 13 wherein the flavoring agent is an anise flavoring agent.

18. The animal feed product of claim 1 wherein the anise flavoring agent is one or both of a licorice flavoring agent and/or an anise flavoring agent.

19. The animal feed product of claim 2 wherein the anise flavoring agent is one or both of a licorice flavoring agent and/or an anise flavoring agent.

20. The animal feed product of claim 8 wherein the anise flavoring agent is one or both of a licorice flavoring agent and/or an anise flavoring agent.
